(19) United States
(12) Patent Application Publication
(10) Pub. No.: US 2004/0073532 A1
(43) Pub. Date: Apr. 15, 2004

(54) Method, system, and program for retrieving an object graph

(75) Inventors: Daniel K. Hiltgen, Los Gatos, CA (US); Paul Von Behren, Boulder, CO (US)

Correspondence Address: David Victor, Esq, 315 South Beverly Dr., Ste. 210, Beverly Hills, CA, 90212, US

(73) Assignee: Sun Mircrosystems, Inc.

(21) Appl. No.: 10/268,513

(22) Filed: Oct. 10, 2002

(51) Int. Cl. G06F 17/30

(52) U.S. Cl. 707/1

(57) ABSTRACT

Disclosed is a system, method, and program for retrieving an object graph. A request for a profile is received in a profile query language. Profile data is retrieved in response to the request. An object graph is generated from the profile using the retrieved profile data.

### BACKGROUND OF THE INVENTION

1. Field of the Invention

The present invention is related to a method, system, and program for retrieving an object graph.

2. Description of the Related Art

A client computer on which client applications run may be connected by a network, such as the Internet, to a server computer. The Internet is a world-wide collection of connected computer networks (i.e., a network of networks). The server computer may be connected to several low level devices. One type of low level device is a redundant array of independent disks (RAID). A RAID device enables storage of the same data on multiple hard disks, thus allowing simultaneous accesses to copies of the data.

The World Wide Web (“Web”) refers to resources (e.g., servers) on the Internet that support the use of Hyptertext Markup Language (“HTML”) documents. Web Based Enterprise Management (WBEM) is a set of management and Internet standard technologies developed by the Distributed Management TaskForce (DMTF), Inc. to unify the management of enterprise computing environments. The DMTF has developed a core set of standards that make up WBEM, which includes a Common Information Model (CIM).

CIM is a standard for an object-oriented model for managing information. The CIM standard is provided by the Distributed Management TaskForce (DMTF), Inc. For further information on the CIM standard, see “Common Information Model (CIM) Specification,” Version 2.2, Jun. 14, 1999. Additional information is available in: “Specification for CIM Operations over HTTP,” Version 1.1, May 2, 2002, hereinafter referred to as “CIM specification,” which is incorporated by reference herein in its entirety.

CIM allows creation of an object graph to represent information, such as a network resource (e.g., an entire network to which several computers and devices are connected or a particular storage device). An object graph may be represented as a block diagram illustrating a logical view of, for example, a SAN or a storage device within a SAN. A storage area network (SAN) is a high-speed network or subnetwork that interconnects shared data storage devices with associated server computers that are accessed by client computers. The object graph may be very complex and may include many objects of different object classes. For example, with CIM, a complex object graph would be created by defining many different object classes. There could be many instances of each of the object classes, leading to for example, thousands of objects in a complex object graph.

With CIM, it is difficult for a client application to retrieve a complete object graph of different object types (i.e., objects instantiated from different classes). In particular, commands provided by CIM allow enumeration of individual classes or individual objects. When an object graph includes objects of different classes, the client application either submits multiple requests, with each request requesting all instances of a specific class or with each request requesting an individual object. For example, if an object graph includes objects of three different classes, the client application may make three requests for objects of each class. Alternatively, if the same object graph includes ten objects, the client application may make ten requests for each object.

If the client application is geographically far from the network resource being managed, there may be a delay in receiving a response for each of the individual requests. With the added delays, retrieval of the object graph may take hours.

Thus, for complex object models, a large number of classes may be required to fully model the problem domain. The client application must make many calls to enumerate instances of each class, which is time consuming and leads to poor performance.

Also, while attempting to obtain an entire object graph, the network resource may be modified before the entire object graph that represents the network resource is received by the client application. For example, by the time the client application receives an object graph of a storage device, a volume may have been deleted. Therefore, by the time the client application receives the object graph, the object graph may not accurately represent the network resource.

The Storage Networking Industry Association (SNIA) is working to develop profiles for some object graphs. A profile describes a particular class of a storage area network (SAN) entity. A class of a SAN entity may describe a device within the SAN, such as a redundant array of independent disks (RAID) device. A RAID device enables storage of the same data on multiple hard disks, thus allowing simultaneous accesses to the copies of data. Thus, a profile provides a description that may be used to build an object graph, but there is still no easy way to access the entire object graph.

Thus, there is a need in the art for improved retrieval of an object graph.

### SUMMARY OF THE INVENTION

Provided are a method, system, and program for retrieving an object graph. A request for a profile is received in a profile query language. Profile data is retrieved in response to the request. An object graph is generated from the profile using the retrieved profile data.

In certain implementations, the request is received at a CIM provider. In certain implementations, the request is a GetProfile<profilename> statement in the profile query language.

In additional implementations, the request is embedded in an ExecQuery statement, and the ExecQuery statement allows specification of the profile query language and a profile query language statement.

In further implementations, a request for a list of supported profiles is received, and the list of supported profiles is returned. In certain implementations, the request requests one of the profiles in the list. In certain implementations, the request is a GetListofProfiles statement in the profile query language.

In yet further implementations, the request is directed to a network resource and the profile data is retrieved through an interface of the network resource.

In certain implementations, the request is received at a CIM provider.

In additional implementations, the object graph is generated by using the profile data to identify objects to be instantiated from classes in the profile.

In further implementations, the object graph is returned to a client application.

In certain implementations, a profile includes a profile instance diagram that identifies associations between classes of the profile and a class diagram that shows inheritance and a description of the classes.

The described implementations of the invention provide a method, system, and program for requesting an object graph. In particular, a new query language, “profile query language,” is provided. A single profile query language statement may be used by a client application to request a profile. Then, profile data is retrieved from a network resource and an object graph is generated using the profile and the profile data.

### BRIEF DESCRIPTION OF THE DRAWINGS

Referring now to the drawings in which like reference numbers represent corresponding parts throughout:

FIG. 1 illustrates, in a block diagram, an architecture in which the invention may be implemented in accordance with certain implementations of the invention

FIG. 2 illustrates, in a block diagram, an alternative architecture in which the invention may be implemented in accordance with certain implementations of the invention.

FIG. 3A illustrates, in a block diagram, a storage device profile instance diagram in accordance with certain implementations of the invention.

FIG. 3B illustrates, in a block diagram, a storage device object graph in accordance with certain implementations of the invention

FIG. 3C illustrates, in a block diagram, a smart toaster profile instance diagram in accordance with certain implementations of the invention.

FIG. 4 illustrates logic for processing a request for a profile in accordance with certain implementations of the invention.

FIG. 5 illustrates logic for processing a request for a profile in accordance with certain implementations of the invention.

FIG. 6 illustrates logic for processing profile data in accordance with certain implementations of the invention.

FIG. 7A illustrates, in a block diagram, a profile super class and sub-classes in accordance with certain implementations of the invention.

FIG. 7B illustrates, in a block diagram, a profile super class, a standards body profile class, and sub-classes in accordance with certain implementations of the invention.

FIG. 8 illustrates one implementation of the architecture of computer systems in accordance with certain implementations of the invention

### DETAILED DESCRIPTION

In the following description, reference is made to the accompanying drawings which form a part hereof and which illustrate several implementations of the present invention. It is understood that other implementations may be utilized and structural and operational changes may be made without departing from the scope of the present invention.

In certain implementations, the invention defines a new query language, which will be referred to herein as “profile query language” (PQL). With implementations of the invention, a PQL statement may be used to retrieve an entire object graph with a single request.

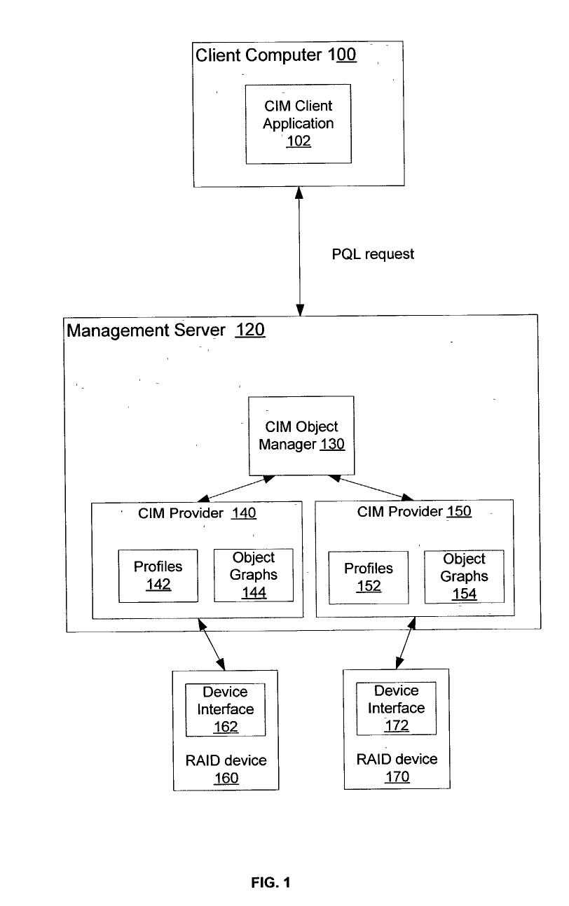

FIG. 1 illustrates, in a block diagram, an architecture in which the invention may be implemented in accordance with certain implementations of the invention. Although the examples herein refer to CIM client applications, CIM object managers, and CIM providers, the technique of the invention is equally applicable to non-CIM client applications, object managers, and providers. A client computer 100 executes a CIM client application 102. The CIM client application 102 may be any management application or enterprise management software for managing, for example, network resources, such as servers and storage devices (e.g., HP OpenView® or IBM Tivoli® Monitoring products). The client computer 100 is connected to a management server 120. The CIM client application 102 may be used to manage the management server 120 or other network resources (e.g., other servers or storage devices) connected to the management server 120.

The management server 120 includes a CIM object manager 130. In certain implementations, the CIM object manager 130 has no knowledge of profiles. The client application 102 sends requests to the CIM object manager 130 For example, the requests may be requests for a list of profiles, a request for a particular profile, or a request to modify a network resource.

The CIM object manager 130 passes requests received from a CIM client application 102 to CIM providers 140 and 150. CIM provider 140 stores one or more profiles 142, and CIM provider 150 stores one or more profiles 152. The CIM provider 140 or 150 stores profiles 142 or 152 and/or object graphs 144 or 154, respectively, that are specific to the device that the particular CIM provider 140 or 150 manages. Requests received from a CIM client application 102 identify a class that the CIM client application 102 is interested in. The CIM object manager 130 maintains a list of classes supported by CIM providers 140 and 150. Based on the class identified in the request, the CIM object manager 130 selects a CIM provider 140 or 150 to respond to the request.

RAID device 160 includes a device interface 162, provided, for example, by a vendor of the RAID device 160. When the CIM provider 140 receives a request for a supported profile, the CIM provider 140 retrieves data from a network resource, generates an object graph, and returns the object graph. In particular, the CIM provider 140 sends requests for data for a profile (also referred to as “profile data”) to the RAID device 160 through device interface 162. Similarly, the CIM provider 150 sends requests for profile data to the RAID device 170 through device interface 172. Profile data includes, for example, the number of instances of an object for a class specified in a profile.

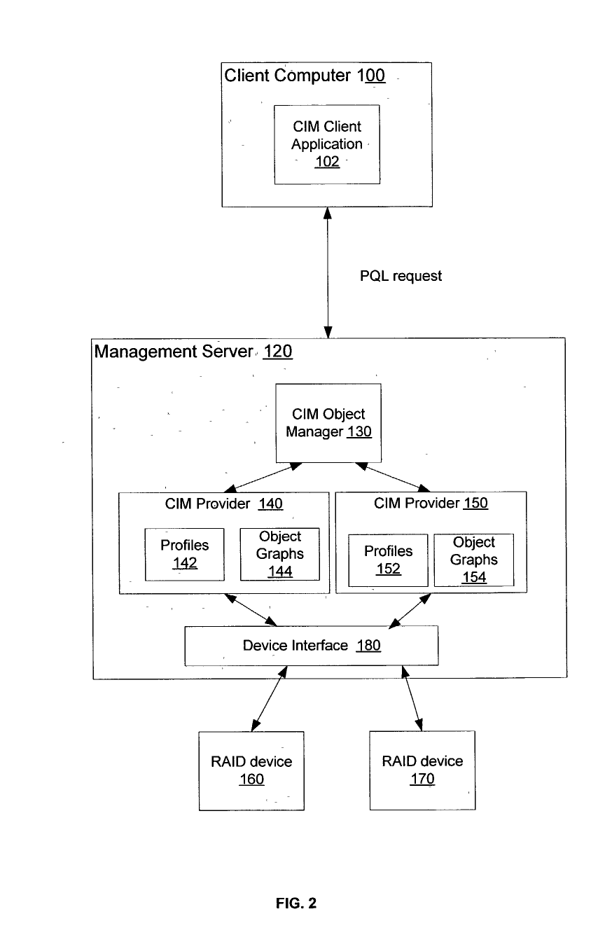

FIG. 2 illustrates, in a block diagram, an alternative architecture in which the invention may be implemented in accordance with certain implementations of the invention. In particular, device interfaces 162 and 172 may be replaced with device interface 180.

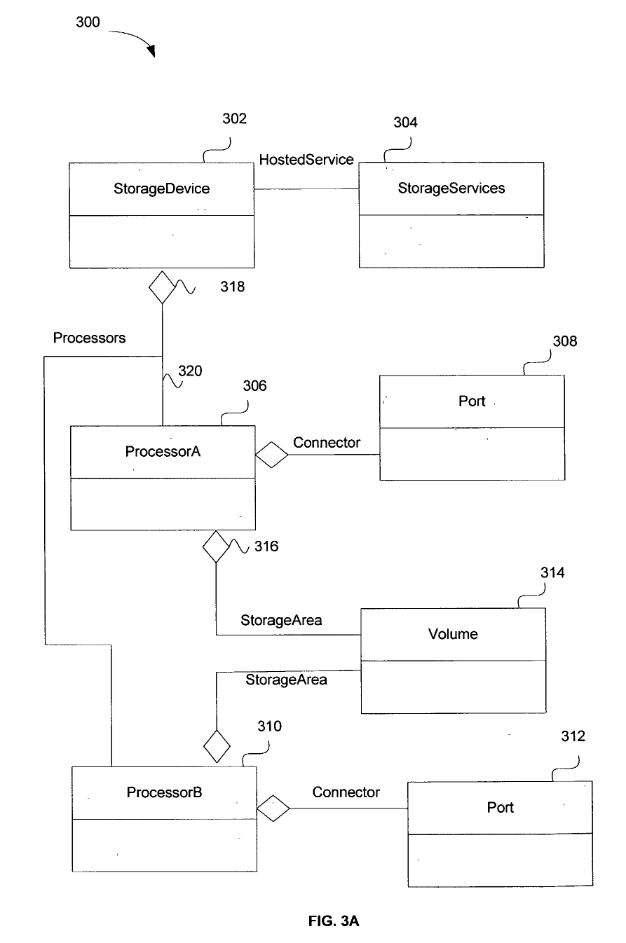

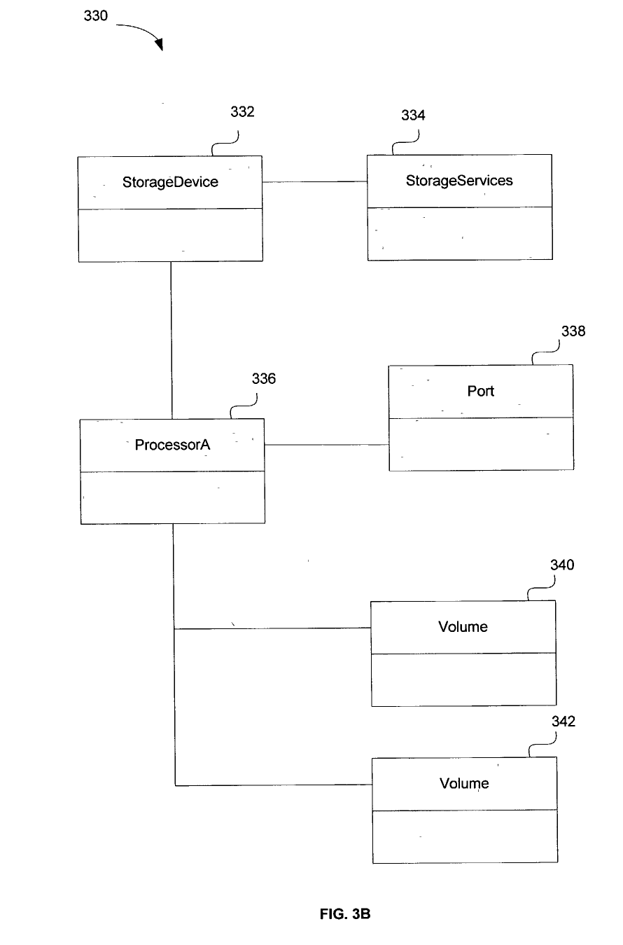

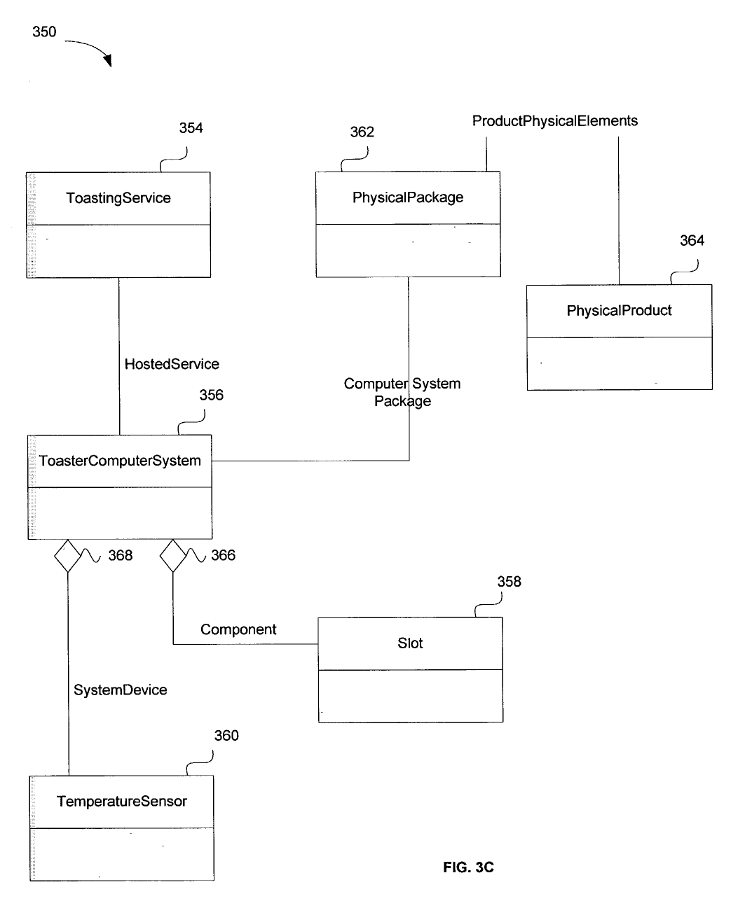

FIG. 3A illustrates, in a block diagram, a storage device profile instance diagram 300 for a profile named “sd_v9_storagedevice” in accordance with certain implementations of the invention. A profile instance diagram (e.g., 300) defines the classes from which an object graph may be instantiated and the associations (i.e., relationships) between the classes. In certain implementations, the profile instance diagram is implemented with a Managed Object File (MOF), which is an ASCII file that formally describes the object graph. For more information on MOF, see “Common Information Model (CIM) Specification,” Version 2.2, Jun. 14, 1999, Distributed Management TaskForce (DMTF), Inc., which is incorporated by reference herein in its entirety.

The storage device profile instance diagram 300 is a logical representation of a storage device. In CIM, classes may be represented in Unified Modeling Language (UML) notation. UML expresses a software system using boxes and lines to represent objects and associations. For example, a class is represented with a box, such as 302. The top portion of the box specifies the name of the class, and the bottom portion of the class may be used to represent data or methods of the class. Also, in CIM, one class is related to another class through an association, which is represented with a connecting line, such as 320, which is labeled with a Processors association. A diamond 318 at the end of a line indicates a many to one association. For example there may be many processor classes (ProcessorA class 306 and ProcessorB class 310) for StorageDevice class 302.

An instance of the StorageDevice class 302 may associated with an instance of the StorageServices class 304 through a HostedService association. StorageServices class 304 may define methods to, for example, add volumes or delete volumes from an instance of the Volume class 314. Moreover, an instance of ProcessorA may be associated with multiple instances of the Port class 308 through a Connector association. Similarly, an instance of the ProcessorB class 310 may be associated with multiple instances of the Port class 312 to through a Connector association. Instances of the ProcessorA class 306 and ProcessorB class 310 may be associated with multiple instances of the Volume class 314.

Other portions of the sd_v9_storagedevice profile include, for example, a profile class diagram showing inheritance and a description of the classes in the profile class.

An object graph 330 that is created based on the profile instance diagram would include objects that were instantiated from the classes defined in the profile instance diagram. For example, in FIG. 3B, a storage device object graph 330 is illustrated in accordance with certain implementations of the invention. The storage device object graph 330 includes a StorageDevice object 332, a StorageServices object 334, a ProcessorA object 336, a Port object 338, and two Volume objects 340 and 342.

Without PQL, in order for the CIM client application 102 to retrieve an object graph based on the storage device profile instance diagram 300, the CIM client application would retrieve the StorageDevice class 302, uses the association to access the NetworkServices class 304, ProcessorA class 306, and ProcesorB class 310. Similarly, the CIM client application 102 would use the associations from the ProcessorA class 306 and ProcessorB class 310 to access the Port classes 308 and 312 and the Volume class 314. For a complex profile instance diagram, it would be very time consuming for the CIM client application to retrieve all of these classes one by one. With PQL, the CIM client application 102 is able to submit one request to obtain the entire object graph 330 based on storage device profile instance diagram 300.

A storage device profile instance diagram has been illustrated in FIG. 3A for ease of explanation. A profile may be used to model any system or information (e.g., any network device, such as a client computer, a server computer, a RAID device, a fiber channel, a network card, etc.) and the techniques of the invention are applicable to any profile of any format. For example, a smart toaster may be a device for toasting food that includes a computer system, and the computer system may be modeled with CIM using a smart toaster profile instance diagram FIG. 3C illustrates, in a block diagram, a smart toaster profile instance diagram 350 for a profile named “st_v1_smarttoaster” in accordance with certain implementations of the invention.

The profile instance diagram 350 is a logical representation of the smart toaster. A ToasterComputerSystem class 356 is the core of the model. An instance of a Slot class 358 is created for each physical slot present in a toaster. For example, if the smart toaster has four slots, there would be four instances of the Slot class 358. Each instance of the Slot class 358 is associated with the ToasterComputerSystem class 356 through a Component association. The diamond 366 at the end of the Component association 357 represents aggregation and indicates that there may be multiple instances of the Slot class 358 for each instance of the ToasterComputerSystem class 356.

An instance of a TemperatureSensor class 360 is provided for each sensor present in the toaster. Each instance of the TemperatureSensor class 360 is associated with the ToasterComputerSystem class 356 through a SystemDevice association. The diamond 368 at the end of the SystemDevice association represents aggregation and indicates that there may be multiple instances of the TemperatureSensor class 360 for each instance of the ToasterComputerSystem class 356.

The toaster may optionally provide a ToastingService class 354, allowing external control of the toaster's operation. The ToastingService class 354 may include methods for starting and stopping the smart toaster. Each instance of the ToastingService class 354 is associated with the ToasterComputerSystem class 356 through a HostedService association.

A PhysicalPackage class 362 provides packaging details about the smart toaster, while a PhysicalProduct class 364 provides product identification. An instance of the PhysicalPackage class 362 is associated with the ToasterComputerSystem class 356 through a Computer System Package association. An instance of the PhysicalProduct class 364 is associated with an instance of the PhysicalPackage class 362 through a Product Physical Elements association.

Other portions of the st_v1_smarttoaster profile include for example, a profile class diagram showing inheritance and a description of the classes in the profile class.

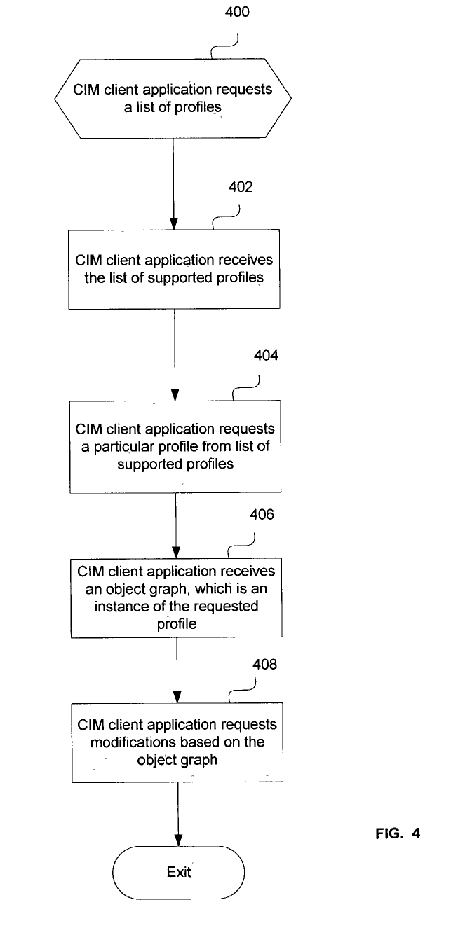

FIG. 4 illustrates logic for processing a request for a profile in accordance with certain implementations of the invention. Control begins at block 400 with the CIM client application 102 requesting a list of supported profiles. The CIM client application 102 sends the request using PQL.

Table A lists some commands of PQL. Table A does not include a complete list of PQL commands and other commands are within the scope of the invention.

TABLE A

| | |
|---|---|
| GetProfile<profilename> | Retrieves a profile; |
| | Input parameter profilename |
| | specifies name of profile; |
| | e.g., Get sd_v9_storagedevice |
| | or Get st_v1_smarttoaster |
| GetListofProfiles | Retrieves a list of supported |
| | profiles. |

CIM/WBEM provide a general mechanism that allows for various query languages to be used. Thus, the profile query language (PQL) of the invention may be used within a CIM/WBEM statement to allow CIM client applications 102 to retrieve object graphs. In particular, the profile query language may be used within an existing CIM/WBEM statement specified in the CIM specification by passing the name of the profile language as one parameter and passing the PQL statement as another parameter. Providing the CIM client application 102 and CIM providers 140 and 150 both recognize the profile, the CIM client application 102 can make one request using the profile query language and retrieve an entire collection of class instances for an object graph.

The ExecQuery statement of CIM/WBEM is defined in Section 2.3.2.13 of the CIM specification and allows use of various query languages:

<object>ExecQuery ([IN] string QueryLanguage, [IN] string Query)

The object parameter specifies the object to which the query is sent. For example, the object may be the StorageDevice object 332. The QueryLanguage input parameter is of type string and defines the query language in which the Query input parameter (also of type string) is expressed. The Query input parameter defines the query to be executed in PQL.

In certain implementations, the PQL language is submitted in the QueryLanguage input parameter, and a PQL command for retrieving a list of supported profiles is submitted in the Query input parameter. The following is an example CIM/WBEM statement in which a PQL statement may be embedded that may be used by the client application 102 to retrieve a list of supported profiles:

<object> ExecQuery (“PQL”, “GetListofProfiles”)

The object specifies an instance of a class. The CIM object manager 130 determines which CIM provider 140 or 150 should process the ExecQuery command based on which CIM provider 140 or 150 supports the class from which the object was instantiated. In certain implementations, each CIM provider 140 or 150 supports a different set of classes. In certain implementations, the CIM providers 140 and 150 may support all or a subset of the same classes, and the CIM object manager 130 sends the ExecQuery command to each of the CIM providers 140 or 150. In certain implementations, when the CIM providers 140 and 150 support all or a subset of the same classes, the CIM object manager 130 may select one or more of the CIM providers 140 or 150 based on various criteria, such as which CIM provider 140 or 150 is least busy and send the ExecQuery command to the selected one or more CIM providers 140 and 150.

Referring to FIG. 4, in block 402, the CIM client application 102 receives the list of supported profiles. For example, the list of supported profiles may list sd_v9_storagdevice and st_v1_smarttoaster. In block 404, the CIM client application 102 requests a particular profile from the list of supported profiles. A request for a profile is considered to be a request for an object graph having objects which are instances of the object classes defined in the profile. A PQL command for retrieving an object graph is submitted in the Query input parameter. The following is an example CIM/WBEM statement in which a PQL statement is embedded that may be used by the client application 102 to retrieve an object graph:

<StorageDevice> ExecQuery (“PQL”, “GetProfile StorageDevice”)

The ExecQuery statement may be directed to, for example, a StorageDevice object. The object that is returned by the ExecQuery statement is the object graph.

Additionally, the CIMSupportedQueryLanguages operation defined in Section 4.5.2.3 of the CIM specification may be used by a CIM client application 102 to determine whether PQL is supported.

In block 405, the CIM client application 102 receives an object graph, which is an instance of the requested profile. In block 408, the CIM client application 102 requests modifications to one or more network resources based on the object graph. For example, if the object graph indicates that a volume of a RAID device is offline, the CIM client application 102 may request that the volume be brought online.

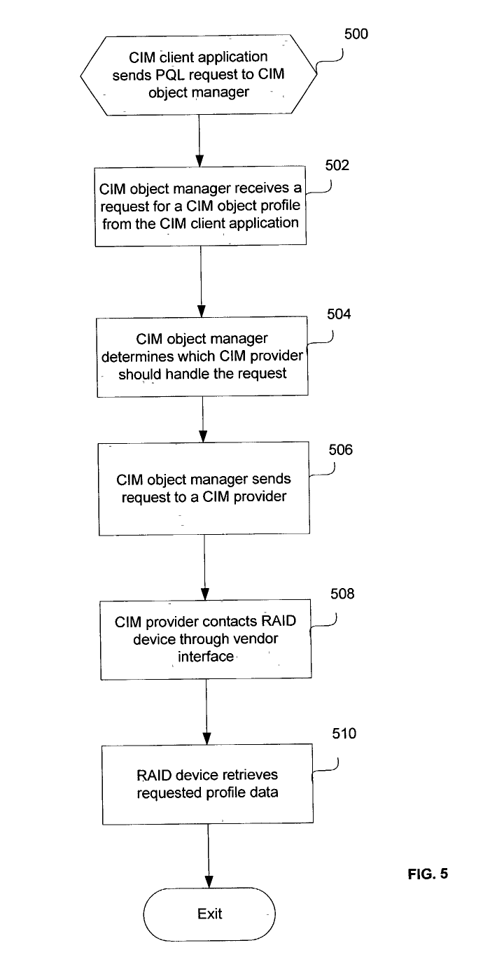

FIG. 5 illustrates logic for processing a request for a profile in accordance with certain implementations of the invention. Control begins at block 500 with a client application sending a PQL request embedded in a CIM/WBEM statement to a CIM object manager. In block 502, the CIM object manager 130 receives the request for a CIM object profile (e.g., an ExecQuery request) from a CIM client application 102. The CIM object manager 130 determines which CIM provider 140 or 150 should handle the request based on which CIM provider supports the class or object specified in the request (block 504). In certain implementations, the class or object specified in the request represents a network resource. The CIM object manager 130 sends the request for the profile to the CIM provider 140 or 150 (block 506).

In certain implementations, before any CIM client application 102 requests are received by a CIM provider 140 or 150, object graphs 144 and 154 are generated from profiles and stored at the CIM provider 140 or 150. Then, the CIM providers 140 and 150 are able to quickly respond to a request for a stored object graph 144 or 154.

In certain implementations, upon receiving a first request, CIM provider 140 or 150 retrieves profile data from one or more devices and generates object graphs from profiles 142 or 152. In particular, the CIM provider 140 or 150 contacts RAID device 160 or 170, respectively, through device interface 162 or 172 to request profile data (block 508). In certain implementations, the CIM provider 140 or 150 determines whether the profile is a supported profile, and, if the profile is not supported, returns an error message that is routed to CIM client application 102. The RAID device 160 or 170 retrieves the requested profile data (block 510).

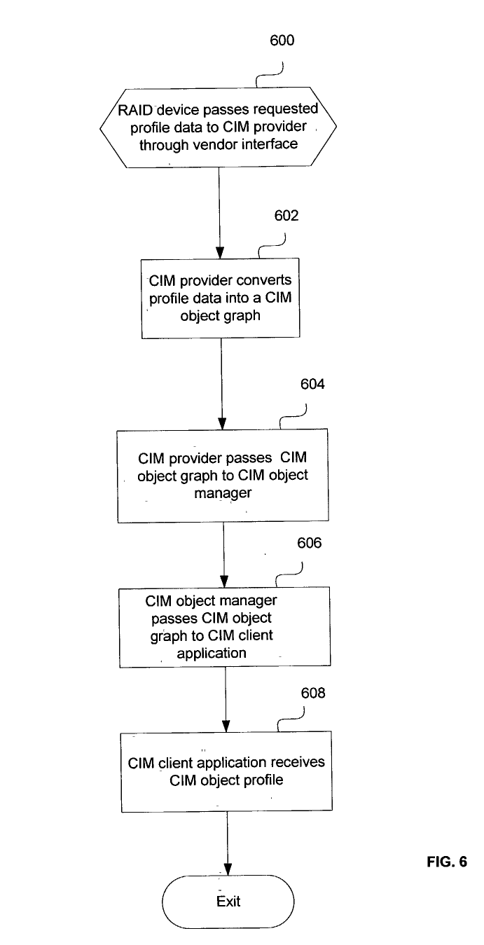

FIG. 6 illustrates logic for processing profile data in accordance with certain implementations of the invention. Control begins at block 600 with the RAID device 160 or 170 passing the requested profile data to a CIM provider 140 or 150 through a device interface 162 or 172. The CIM provider 140 or 150 converts the profile data into a CIM object graph (block 602). In certain implementations, the developer who creates the CIM provider 140 or 150 implements a conversion technique to convert the profile data into an object graph. In certain implementations, the profile provides a template of an object graph, and the profile data is used to build the object graph from the template. The CIM provider 140 or 150 passes the CIM object graph to the CIM object manager 130 (block 604). The CIM object manager 130 passes the CIM object graph to the CIM client application 102 (block 606). The CIM client application 102 receives the CIM object graph and displays the CIM object graph. In certain implementations, the CIM object graph is in static form, and changes to the profile data are not automatically relayed to the client application 102.

In certain implementations, for example, when the communication path between the provider 140 or 150 and device 160 or 170 is fast, the provider 140 or 160 retrieves profile data from device 160 or 170 and generates object graphs upon receiving a request from a CIM client application 102. In certain implementations, for example, when communication between the CIM provider 140 or 150 and the device 160 or 170 is slow, the provider 140 or 150 retrieves profile data from device 160 or 170 and builds object graphs for each profile 142 or 152.

Thus, the invention defines a new query language that allows CIM client applications to retrieve object graphs (or profile instances). Providing the client and CIM both recognize the profile, the client can make one request using the profile query language and retrieve an entire collection of class instances for a profile.

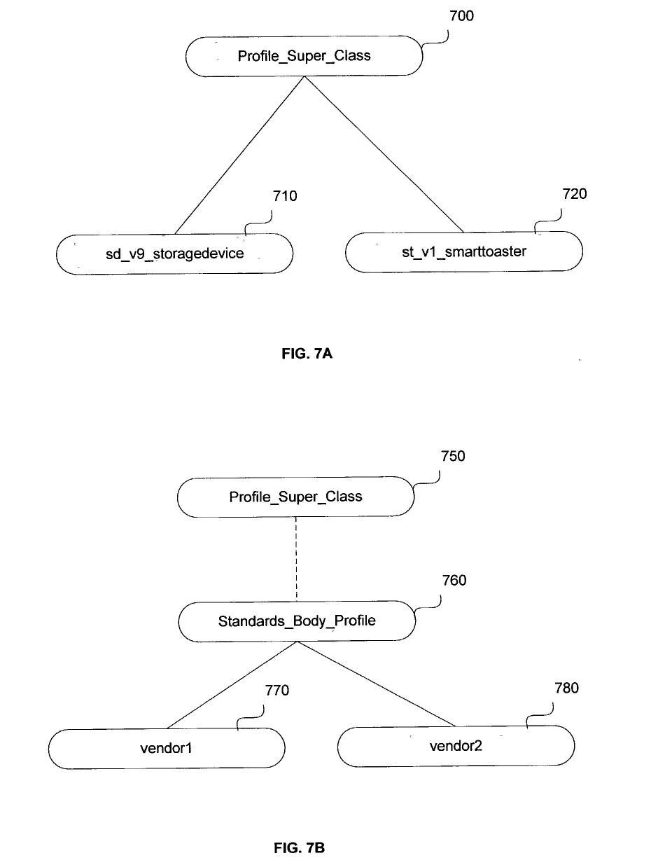

In certain implementations, a set of well defined CIM classes may be used to identify profiles using the GetListOfProfiles statement. In particular, a “profile super class” is defined by certain implementations of the invention. Then, each profile is a sub-class of the profile super class. FIG. 7A illustrates, in a block diagram, a profile super class and sub-classes in accordance with certain implementations of the invention. In particular, sd_v9_storagedevice class 710 for the sd_v9_storagedevice profile and the st_v1_smarttoaster class 720 for the st_v1_smarttoaster profile are sub-classes of the Profile_Super_Class class 700.

When a CIM client application 102 wants to discover which profiles are available, the CIM client application 102 issues a GetListofProfiles statement specifying the profile super class as the class to which the ExecQuery statement is issued, which, for ease of reference will be named Profile_Super Class (e.g., Profile_Super_Class ExecQuery (“PQL”, “GetListofProfiles”). The response would be instances of the various profile classes (“profile class instances”) that each CIM provider 140 and 150 supports. In certain implementations, the response indicates which profile classes each CIM provider 140 and 150 supports. The client application 102 could then issue a GetProfile statement to the profile class instances to obtain object graphs.

In certain additional implementations, the client application 102 could specify an EnumerateInstances statement of CIM/WBEM, which is defined in Section 2.3.2.11 of the CIM specification and is used to enumerate instances of a CIM class, such as Profile_SuperClass. The EnumerateInstances statement has the following format:

<namedInstance>*EnumerateInstances (
[IN] <className> ClassName,
[IN,OPTIONAL] boolean LocalOnly = true,
[IN,OPTIONAL] boolean DeepInheritance = true,
[IN,OPTIONAL] boolean IncludeQualifiers = false,
[IN,OPTIONAL] boolean IncludeClassOrigin = false,
[IN,OPTIONAL,NULL] string PropertyList [] = NULL
)

The ClassName input parameter defines the class that is the basis for the enumeration. The optional LocalOnly and DeepInheritance input parameters describe the elements for properties that are to be included as part of the returned namedInstances structure. If the optional IncludeQualifiers input parameter is true, all qualifiers for each Instance are included as <QUALIFIER> elements in the response. If the optional IncludeClassOrigin input parameter is true, a CLASSORIGIN attribute is present on all appropriate elements in each returned Instance. If the optional PropertyList input parameter is not NULL, the members of the array define one or more Property names of the designated class.

Thus, a client application 102 may submit the following statement to obtain instance names for the profile super class in a structure named profile_super_class_instances:

<profile_super_class_instances>*EnumerateInstances

(Profile_Super_Class ClassName)

In certain further implementations, a standards body, such as the Distributed Management TaskForce (DMTF) or the Storage Networking Industry Association (SNIA), may define a profile and specify a standards body profile class name (e.g., Standards_Body_Profile class), and each vendor may create specific classes that are sub-classes of the Standards_Body_Profile class and that provide vendor specific implementations of the Standards_Body_Profile class. Then, CIM client applications 102 could either discover which profiles are available by issuing a GetListofProfiles statement specifying the standards body profile class as the class to which the ExecQuery statement is issued, (e.g., Standards_Body_Profile ExecQuery (“PQL”, “GetListofProfiles”) or enumerate instances of the standards body profile class in a structure called standards_body profile_instances (e.g., <standards_body_profile_instances>*EnumerateInstances (Standards_Body_Profile ClassName)) without understanding different vendors' implementations of the standards body profile class. In this manner, it is simple to obtain vendor specific implementations of the standards body profile class. The standards body profile class could optionally be a sub-class of the profile super class.

FIG. 7B illustrates, in a block diagram, a profile super class, a standards body profile class, and sub-classes in accordance with certain implementations of the invention. In particular, vendor1 class 770 and the vendor2 class 780 are sub-classes of the Standards_Body_Profile class 760 and represent vendor specific implementations of the standards body profile class. The dashed line connecting the Profile Super_Class class 750 to the Standards_Body_Profile class 760 is used to illustrate that the Standards_Body_Profile class 760 may optionally be a subclass of the Profile_Super_Class class 750.

OpenView is a registered trademark of Hewlett-Packard Company. Tivoli is a registered trademark of International Business Machines, Inc.

### Additional Implementation Details

The above described implementations for creating consistent copies may be implemented using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.)). Code in the computer readable medium is accessed and executed by a processor. The code may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

The logic of FIGS. 4-6 describe specific operations occurring in a particular order. In alternative implementations, certain of the logic operations may be performed in a different order, modified or removed. Morever, steps may be added to the above described logic and still conform to the described implementations. Further, operations described herein may occur sequentially or certain operations may be processed in parallel, or operations described as performed by a single process may be performed by distributed processes.

The logic of FIGS. 4-6 was described as being implemented in software. This logic may be part of the operating system of the host systems or an application program. In yet further implementations, this logic may be maintained in storage areas managed by the control units or in a read only memory or other hardwired type of device. The preferred logic may be implemented in hard disk drives or in programmable and non-programmable gate array logic.

In certain implementations, the CIM providers 140 and 150 may be part of the CIM object manager 130.

Although the examples herein refer to CIM client applications 102, CIM object managers 130, and CIM providers 140 and 150, the technique of the invention is equally applicable to non-CIM client applications, object managers, and providers or any combination of CIM and non-CIM client applications, object managers, and providers.

In certain implementations, the management server 120 may be inside a RAID device 160 or 170. In certain implementations, the management server 120 may be a management appliance that is sold with the RAID device 160 or 170. In certain implementations, the management server 120 may be replaced by management server software that is installed on the client 100 for accessing the RAID device 160 or 170 as a proxy management solution.

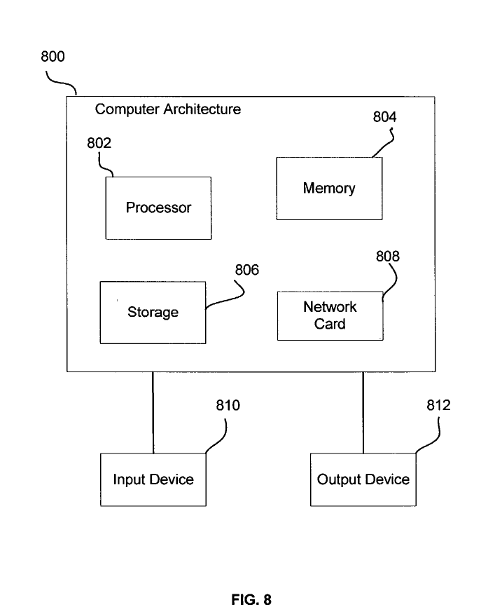

FIG. 8 illustrates one implementation of the architecture of the computer systems 100 and 120 in accordance with certain implementations of the invention. The computer systems 100 and 120 may implement a computer architecture 800 having a processor 802 (e.g., a microprocessor), a memory 804 (e.g., a volatile memory device), and storage 806 (e.g., a non-volatile storage, such as magnetic disk drives, optical disk drives, a tape drive, etc.). The storage 806 may comprise an internal storage device or an attached or network accessible storage. Programs in the storage 806 are loaded into the memory 804 and executed by the processor 802 in a manner known in the art. The architecture further includes a network card 808 to enable communication with a network. An input device 810 is used to provide user input to the processor 802, and may include a keyboard, mouse, pen-stylus, microphone, touch sensitive display screen, or any other activation or input mechanism known in the art. An output device 812 is capable of rendering information transmitted from the processor 802, or other component, such as a display monitor, printer, storage, etc.

The foregoing description of the preferred implementations of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many implementations of the invention can be made without departing from the spirit and scope of the invention, the invention resides in the claims hereinafter appended.

What is claimed is:

1. A method for retrieving an object graph, comprising:
receiving a request for a profile in a profile query language;
retrieving profile data in response to the request; and
generating an object graph from the profile using the retrieved profile data.

2. The method of claim 1, further comprising:
receiving the request at a CIM provider.

3. The method of claim 1, wherein the request comprises a GetProfile<profilename> statement in the profile query language.

4. The method of claim 1, wherein the request is embedded in an ExecQuery statement.

5. The method of claim 4, wherein the ExecQuery statement allows specification of the profile query language and a profile query language statement.

6. The method of claim 1, further comprising:
receiving a request for a list of supported profiles.

7. The method of claim 6, wherein the request comprises a GetListofprofiles statement in the profile query language.

8. The method of claim 6, further comprising:
returning the list of supported profiles.

9. The method of claim 6, wherein the request requests one of the profiles in the list.

10. The method of claim 1, wherein the request is directed to a network resource and further comprising:
retrieving the profile data through an interface of the network resource.

11. The method of claim 1, further comprising:
generating the object graph by using the profile data to identify objects to be instantiated from classes in the profile.

12. The method of claim 1, further comprising:
returning the object graph to a client application.

13. The method of claim 1, further comprising:
generating the request in the profile query language at a client application;
embedding the request in the profile query language into an ExecQuery statement; and
transmitting the ExecQuery statement to a CIM object manager.

14. The method of claim 13, further comprising:
identifying at the CIM object manager a CIM provider to handle the request; and
forwarding the request from the CIM object manager to the identified CIM provider.

15. The method of claim 14, wherein identifying further comprises:
selecting the CIM provider that supports the network resource specified in the request.

16. The method of claim 15, wherein the network resource is represented by a class or object in the request.

17. The method of claim 15, wherein multiple CIM providers support the network resource specified in the request and further comprising:
forwarding the request from the CIM object manager to each of the multiple CIM providers.

18. The method of claim 14, further comprising:
transmitting a profile data request from the CIM provider to a network resource specified in the request in the profile query language;
receiving the profile data from the network resource for use in generating the object graph; and
returning the generated object graph to the CIM object manager.

19. The method of claim 18, further comprising:
receiving the generated object graph at the client application from the CIM object manager; and
requesting a modification of the network resource based on review of the generated object graph.

20. The method of claim 19, further comprising:
receiving the request for profile data at the network resource from the CIM provider; and
returning profile data to the CIM provider, wherein the profile data comprises a number of instances of each object of each class specified in the profile.

21. The method of claim 1, wherein a profile comprises a profile instance diagram that identifies associations between classes of the profile and a class diagram that shows inheritance and a description of the classes.

22. The method of claim 1, further comprising:
providing a profile super class.

23. The method of claim 22, wherein the request comprises a GetListofProfiles statement embedded in an ExecQuery statement directed to the profile super class.

24. The method of claim 22, further comprising:
receiving an EnumerateInstances statement for the profile super class.

25. The method of claim 22, wherein profile classes are sub-classes of the profile super class.

26. The method of claim 1, wherein a standards body profile class is available.

27. The method of claim 26, wherein a vendor specific implementation of the standards body profile class is available.

28. The method of claim 26, wherein the request comprises a GetListofProfiles statement embedded in an ExecQuery statement directed to the standards body profile class.

29. The method of claim 26, further comprising:
receiving an EnumerateInstances statement for the standards body profile class.

30. The method of claim 26, wherein the standards body profile class comprises a sub-class of a profile super class.

31. A system for retrieving an object graph, comprising:
means for receiving a request for a profile in a profile query language;
means for retrieving profile data in response to the request; and
means for generating an object graph from the profile using the retrieved profile data.

32. The system of claim 31, further comprising:
means for receiving the request at a CIM provider.

33. The system of claim 31, wherein the request comprises a GetProfile<profilename> statement in the profile query language.

34. The system of claim 31, wherein the request is embedded in an ExecQuery statement.

35. The system of claim 34, wherein the ExecQuery statement allows specification of the profile query language and a profile query language statement.

36. The system of claim 31, further comprising:
means for receiving a request for a list of supported profiles.

37. The system of claim 36, wherein the request comprises a GetListofProfiles statement in the profile query language.

38. The system of claim 36, further comprising:
means for returning the list of supported profiles.

39. The system of claim 36, wherein the request requests one of the profiles in the list.

40. The system of claim 31, wherein the request is directed to a network resource and further comprising:
means for retrieving the profile data through an interface of the network resource.

41. The system of claim 31, further comprising:
means for generating the object graph by using the profile data to identify objects to be instantiated from classes in the profile.

42. The system of claim 31, further comprising:
means for returning the object graph to a client application.

43. The system of claim 31, further comprising:
means for generating the request in the profile query language at a client application;
means for embedding the request in the profile query language into an ExecQuery statement; and
means for transmitting the ExecQuery statement to a CIM object manager.

44. The system of claim 43, further comprising:
means for identifying at the CIM object manager a CIM provider to handle the request; and
means for forwarding the request from the CIM object manager to the identified CIM provider.

45. The system of claim 44, wherein identifying further comprises:
means for selecting the CIM provider that supports the network resource specified in the request.

46. The system of claim 45, wherein the network resource is represented by a class or object in the request.

47. The system of claim 45, wherein multiple CIM providers support the network resource specified in the request and further comprising:
means for forwarding the request from the CIM object manager to each of the multiple CIM providers.

48. The system of claim 44, further comprising:
means for transmitting a profile data request from the CIM provider to a network resource specified in the request in the profile query language;
means for receiving the profile data from the network resource for use in generating the object graph; and
means for returning the generated object graph to the CIM object manager.

49. The system of claim 48, further comprising:
means for receiving the generated object graph at the client application from the CIM object manager; and
means for requesting a modification of the network resource based on review of the generated object graph.

50. The system of claim 49, further comprising:
means for receiving the request for profile data at the network resource from the CIM provider; and
means for returning profile data to the CIM provider, wherein the profile data comprises a number of instances of each object of each class specified in the profile.

51. The system of claim 31, wherein a profile comprises a profile instance diagram that identifies associations between classes of the profile and a class diagram that shows inheritance and a description of the classes.

52. The system of claim 31, further comprising:
means for providing a profile super class.

53. The system of claim 52, wherein the request comprises a GetListofprofiles statement embedded in an ExecQuery statement directed to the profile super class.

54. The system of claim 52, further comprising:
means for receiving an EnumerateInstances statement for the profile super class.

55. The system of claim 52, wherein profile classes are sub-classes of the profile super class.

56. The system of claim 31, wherein a standards body profile class is available.

57. The system of claim 56, wherein a vendor specific implementation of the standards body profile class is available.

58. The system of claim 56, wherein the request comprises a GetListofProfiles statement embedded in an ExecQuery statement directed to the standards body profile class.

59. The system of claim 56, further comprising:
means for receiving an EnumerateInstances statement for the standards body profile class.

60. The system of claim 56, wherein the standards body profile class comprises a sub-class of a profile super class.

61. A article of manufacture for retrieving an object graph, wherein the article of manufacture is capable of causing operations, the operations comprising:
receiving a request for a profile in a profile query language;
retrieving profile data in response to the request; and
generating an object graph from the profile using the retrieved profile data.

62. The article of manufacture of claim 61, the operations further comprising:
receiving the request at a CIM provider.

63. The article of manufacture of claim 61, wherein the request comprises a GetProfile<profilename> statement in the profile query language.

64. The article of manufacture of claim 61, wherein the request is embedded in an ExecQuery statement.

65. The article of manufacture of claim 64, wherein the ExecQuery statement allows specification of the profile query language and a profile query language statement.

66. The article of manufacture of claim 61, the operations further comprising:
receiving a request for a list of supported profiles.

67. The article of manufacture of claim 66, wherein the request comprises a GetListofProfiles statement in the profile query language.

68. The article of manufacture of claim 66, the operations further comprising:
returning the list of supported profiles.

69. The article of manufacture of claim 66, wherein the request requests one of the profiles in the list.

70. The article of manufacture of claim 61, wherein the request is directed to a network resource and the operations further comprising:
retrieving the profile data through an interface of the network resource.

71. The article of manufacture of claim 61, the operations further comprising:
generating the object graph by using the profile data to identify objects to be instantiated from classes in the profile.

72. The article of manufacture of claim 61, the operations further comprising:
returning the object graph to a client application.

73. The article of manufacture of claim 61, the operations further comprising:
generating the request in the profile query language at a client application;
embedding the request in the profile query language into an ExecQuery statement; and
transmitting the ExecQuery statement to a CIM object manager.

74. The article of manufacture of claim 73, the operations further comprising:
identifying at the CIM object manager a CIM provider to handle the request; and
forwarding the request from the CIM object manager to the identified CIM provider.

75. The article of manufacture of claim 74, wherein the operations for identifying further comprise:
selecting the CIM provider that supports the network resource specified in the request.

76. The article of manufacture of claim 75, wherein the network resource is represented by a class or object in the request.

77. The article of manufacture of claim 75, wherein multiple CIM providers support the network resource specified in the request and the operations further comprising:
forwarding the request from the CIM object manager to each of the multiple CIM providers.

78. The article of manufacture of claim 74, the operations further comprising:
transmitting a profile data request from the CIM provider to a network resource specified in the request in the profile query language;
receiving the profile data from the network resource for use in generating the object graph; and
returning the generated object graph to the CIM object manager.

79. The article of manufacture of claim 78, the operations further comprising:
receiving the generated object graph at the client application from the CIM object manager; and
requesting a modification of the network resource based on review of the generated object graph.

80. The article of manufacture of claim 79, the operations further comprising:
receiving the request for profile data at the network resource from the CIM provider; and
returning profile data to the CIM provider, wherein the profile data comprises a number of instances of each object of each class specified in the profile.

81. The article of manufacture of claim 61, wherein a profile comprises a profile instance diagram that identifies associations between classes of the profile and a class diagram that shows inheritance and a description of the classes.

82. The article of manufacture of claim 61, the operations further comprising:
providing a profile super class.

83. The article of manufacture of claim 82, wherein the request comprises a GetListofProfiles statement embedded in an ExecQuery statement directed to the profile super class.

84. The article of manufacture of claim 82, the operations further comprising:
receiving an EnumerateInstances statement for the profile super class.

85. The article of manufacture of claim 82, wherein profile classes are sub-classes of the profile super class.

86. The article of manufacture of claim 61, wherein a standards body profile class is available.

87. The article of manufacture of claim 86, wherein a vendor specific implementation of the standards body profile class is available.

88. The article of manufacture of claim 86, wherein the request comprises a GetListofProfiles statement embedded in an ExecQuery statement directed to the standards body profile class.

89. The article of manufacture of claim 86, the operations further comprising:
receiving an EnumerateInstances statement for the standards body profile class.

90. The article of manufacture of claim 86, wherein the standards body profile class comprises a sub-class of a profile super class.
